(19) United States
(12) Patent Application Publication
(10) Pub. No.: US 2007/0026523 A1
(43) Pub. Date: Feb. 1, 2007

(54) Method for stabilizing leuco dye

(75) Inventors: Yuriko Taniguchi, Ryugasaki-shi (JP); Tomohisa Nishio, Ryugasaki-shi (JP); Koji Ushizawa, Ryugasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: DAIICHI PURE CHEMICALS CO., LTD., Chuo-ku (JP)

(21) Appl. No.: 11/492,082

(22) Filed: Jul. 25, 2006

Related U.S. Application Data
(60) Provisional application No. 60/702,630, filed on Jul. 27, 2005.

(51) Int. Cl. G01N 31/00

(52) U.S. Cl. 436/18

(57) ABSTRACT

Provided is a method for stabilizing a leuco dye, the method including storing a leuco dye in a solution in the co-presence of a protease protein.

### BACKGROUND OF THE INVENTION

1. Field of the Invention

The present invention relates to a method for stabilizing a leuco dye employed for assaying minor components of a biological sample, and to a leuco dye stabilizing reagent.

2. Background Art

Assay of biological components of blood, urine, or the like is essential for the diagnosis, of disease, elucidation of pathological conditions, or assessment of therapeutic processes, since variation in such components is significantly associated with diseases. For example, various methods have been developed for assaying a wide variety of minor components, such as blood cholesterol, triglyceride, glucose, uric acid, phospholipid, bile acid, and monoamine oxidase, and such methods are actually used in disease diagnosis.

Currently prevailing methods for assaying serum components include enzymatic methods, in which an enzyme that acts specifically on a target component is caused to act on the component, and the resultant product is assayed for determination of the amount of the target component. In a generally employed enzymatic method, an oxidase that acts specifically on a target component is caused to act on the component, to thereby generate hydrogen peroxide; a reagent which develops color when oxidized (hereinafter may be referred to as an “oxidizable color-developing reagent”) (i.e., a color-developing component) is oxidized with the hydrogen peroxide in the presence of peroxidase (POD), to thereby cause the reagent to develop color; and the amount of the target component is determined through calorimetric analysis of the thus-developed color. Examples of known oxidizable color-developing reagents employed for such an enzymatic method include a Trinder reagent, which is a phenolic, aniline, or toluidine chromogen and forms a dye through oxidation-condensation with a coupler (e.g., 4-aminoantipyrine aminoantipyrine (4-AA) or 3-methyl-2-benzothiazolinonehydrazone (MBTH) in the presence of POD. However, a color-developing system employing such an oxidizable color-developing reagent has disadvantages in that the system exhibits low sensitivity for quantification of minor components, and the system, which has an absorption maximum within a short-wavelength region, is prone to be affected by hemoglobin, bilirubin, etc. contained in a sample to be assayed. In recent years, there have been reported numerous methods employing, as an oxidizable color-developing reagent overcoming such disadvantages, a leuco dye (e.g., a triphenylmethane leuco dye) which directly develops color through oxidation in the presence of POD (see, for example, JP-A-1985-184400: and JP-A-91-206896). JP-A-91-206896 discloses that such a leuco dye (e.g., a triphenylmethane leuco dye) exhibits very high measurement sensitivity and thus is suitable for quantification of minor components, and the dye enables employment of a phosphate buffer, a Good's buffer, or a similar buffer.

However, a leuco dye poses a problem in that the dye exhibits insufficient stability when stored in a solution, and gradually develops color during storage. In order to solve such a problem, there has been proposed a method in which N,N,N′,N′,N″,N″-hexa-3-sulfopropyl-4,4′,4″-triaminotriphenylmethane (TPM-PS: product of Dojindo Laboratories), which is a triphenylmethane leuco dye, is stabilized with a Good's buffer or a similar buffer, thereby preventing nonspecific color development (JP-A-2005-110507). However, this method is difficult to apply to practical use (i.e., long-term storage), and thus has not yet been put into practice. In addition, this method still poses a problem in terms of nonspecific color development over time during storage of the dye in a solution.

### SUMMARY OF THE INVENTION

Therefore, an object of the present invention is to provide a method for stably storing an oxidizable color-developing reagent (in particular, a leuco dye). Another object of the present invention is to provide a leuco dye stabilizing reagent.

In view of the foregoing, the present inventors have conducted extensive studies, and as a result have found that when a leuco dye is stored in a solution having a pH of 6 or thereabouts in the co-presence of a protease protein, the leuco dye can be stably stored over a long period of time. The present invention has been accomplished on the basis of this finding.

Accordingly, the present invention provides a method for stabilizing a leuco dye, comprising storing a leuco dye in a solution in the co-presence of a protease protein.

The present invention also provides a leuco dye solution containing at least a protease protein.

The present invention also provides a method of employing a protease protein as a leuco dye stabilizing agent.

The present invention also provides a method for assaying hemoglobin Alc (HbAlc), comprising the following steps:

a. a step of hemolyzing blood cells by use of a surfactant; f

b. a step of cleaving hemoglobin Alc at its β-chain amino terminus by use of a protease which coexists with a leuco dye, thereby providing a fructosyl amino acid or a fructosyl dipeptide;

c. a step of causing an oxidase to act on the fructosyl amino acid or fructosyl dipeptide, the oxidase being specific to the amino acid or dipeptide, thereby generating hydrogen peroxide; and

d. a step of oxidizing the leuco dye with the generated hydrogen peroxide in the presence of a peroxidase, thereby causing the leuco dye to develop color.

The present invention also provides a reagent for use in a method for assaying hemoglobin Alc, the method comprising the following steps:

a. a step of hemolyzing blood cells by use of a surfactant;

b. a step of cleaving hemoglobin Alc at its β-chain amino terminus by use of a protease protein which coexists with a leuco dye, thereby providing a fructosyl amino acid or a fructosyl dipeptide;

c. a step of causing an oxidase to act on the fructosyl amino acid or fructosyl dipeptide, the oxidase being specific to the amino acid or dipeptide, thereby generating hydrogen peroxide; and

d. a step of oxidizing the leuco dye with the generated hydrogen peroxide in the presence of a peroxidase, thereby causing the leuco dye to develop color.

According to the stabilization method of the present invention, a leuco dye can be stably stored in a solution over a long period of time. Employment of the leuco dye solution of the present invention enables highly sensitive assay of a minor component of a biological sample; in particular, hemoglobin Alc. Therefore, the leuco dye solution of the present invention is very useful in the field of clinical examination.

### BRIEF DESCRIPTION OF THE DRAWING

FIG. 1 shows correlation between HbAlc level (%) in the case of Referential Example in which a commercially available kit is employed and that in the case of Example 2.

### DETAILED DESCRIPTION OF PREFERRED EMBODIMENTS

The leuco dye solution of the present invention may be employed in any oxidizing substance quantification method which employs a leuco dye as a color-developing component, so long as the protease protein coexisting with the leuco dye causes substantially no problems in the method. Examples of the oxidizing substance include hydrogen peroxide. The leuco dye solution of the present invention is particularly useful for the assay of minor components of a biological sample, in which an oxidase is caused to act on a substrate or a substance generated through enzymatic reaction, and the thus-generated hydrogen peroxide is quantified.

Such a minor component may be any biological component which enables generation of hydrogen peroxide through enzymatic reaction. Examples of such components include glycosylated proteins, glycosylated peptides, glycosylated amino acids, cholesterol, glucose, glycerin, triglyceride, free fatty acids, uric acid, phospholipid, sialic acid, bile acid, pyruvic acid, inorganic phosphorus, creatinine, creatine, GOT, GPT, monoamine oxidase, guanase, cholinesterase, and D,L-amino acids. Among glycosylated proteins, glycosylated hemoglobins are preferred, with hemoglobin Alc being particularly preferred.

Examples of the leuco dye employed in the present invention include triphenylmethane leuco dyes. The triphenylmethane leuco dyes may be highly water-soluble compounds described in, for example, JP-A-91-206896 and JP-A-94-197795. Among such leuco dyes, for example, N,N,N′,N′,N″,N″-hexa-3-sulfopropyl-4,4′,4″-triaminotriphenylmethane (TPM-PS: product of Dojindo Laboratories) is preferred.

Examples of preferred protease proteins coexisting with the leuco dye include protease proteins derived from microorganisms belonging to, for example, the genus Bacillus, the genus Aspergillus, and the genus Streptomyces. Other preferred examples include serine proteases such as chymotrypsin. Among these proteases, the protease employed in the case where the leuco dye solution of the present invention is applied to assay of hemoglobin Alc is preferably a protease capable of cleaving hemoglobin Alc at its β-chain amino terminus, thereby providing a fructosylated amino acid (i.e., fructosyl valine) or a fructosylated dipeptide (i.e., fructosyl valyl histidine). Examples of such proteases include Subtilisin for the genus Bacillus, Aspergillopepsin I or Protease type XXIII for the genus Aspergillus, and Mycolysin for the genus Streptomyces. Such Subtilisin includes Protin PC10OF and Protin NC25 (products of Daiwa Kasei K.K.), which are proteases derived from Bacillus subtilis. Aspergillopepsin I includes Molsin (Product of Kikkoman Corporation), which is protease derived from Aspergillus saitoi. And Protease type XXIII (product of Sigrma), which is protease derived from Aspergillus oryzae. Mycolysin includes Actinase AS, Actinase AF, and Actinase E (products of Kaken Pharmaceutical Co., Ltd.), and Protease Type-XIV (product of Sigma), which are proteases derived from Streptomyces griseus. In addition to such microorganism-derived proteases, chymotrypsin or the like exhibits a leuco dye stabilizing effect. The protease which is caused to coexist with the leuco dye may be employed as it is, or may be subjected to inactivation treatment. The protease inactivation treatment may be a generally employed enzyme inactivation treatment. For the sake of convenience, the protease may be thermally treated at 70° C. for about 10 to about 20 minutes such that the protein does not coagulate.

In the case where the leuco dye solution of the present invention is employed for assay of HbAlc, no particular limitation is imposed on the concentration of a protease protein to be employed, so long as the enzyme concentration is enough for cleavage of the aforementioned fructosyl valine or fructosyl valyl histidine at the β-chain amino terminus. The protease concentration may be determined in consideration of, for example, the specific activity of the enzyme, and in accordance with the concentration of the leuco dye. For example, the concentration of the protease is 0.001 to 10 mg/mL, preferably 0.05 to 5 mg/mL. More concretely, for example, in the case where TPM-PS (25 μM) is employed as a leuco dye, and Protin PC10F is employed as a protease, the concentration of the protease is preferably 0.01 to 10 mg/mL, more preferably 0.05 to 5 mg/mL.

Any buffer may be employed, so long as it can maintain the pH of the leuco dye solution at about 5 to about 7. Example of the buffer which may be employed include inorganic acids such as sulfuric acid and phosphoric acid; organic acids such as glycine, phthalic acid, maleic acid, citric acid, succinic acid, oxalic acid, tartaric acid, acetic acid, and lactic acid; and Good's buffers. No particular limitation is imposed on the concentration of the buffer, but the buffer concentration is preferably 0.1 to 1,000 mM, particularly preferably 5 to 500 mM. The pH may be 5 to 7, but is particularly preferably 6 or thereabouts.

The concentration of the leuco dye contained in the leuco dye solution may be appropriately determined in consideration of the color developing sensitivity. The leuco dye concentration is generally 0.001 to 10 mM, preferably 0.01 to 1 mM, particularly preferably 0.05 to 0.5 mM.

The leuco dye solution of the present invention may also contain, for example, an anionic surfactant; a nonionic surfactant; an enzyme for treating contaminants in blood; a reaction-controlling agent; a stabilizer; a protein such as albumin; a salt such as sodium chloride, calcium chloride, potassium chloride, or potassium ferrocyanide; an amino acid such as lysine, alanine, aspartic acid, or glutamic acid; a peptide; a polyamino acid; a tetrazolium salt for preventing the effects of a reducing substance; an antibiotic; an antiseptic agent such as sodium azide or boric acid; or a cationic surfactant etc. The amount of such an additive may be appropriately determined according to a known enzymatic quantification method employing a leuco dye.

The leuco dye solution of the present invention may be provided by being charged into, for example, a glass bottle or a plastic container. More preferably, such a container is shielded from light.

Next will be described an HbAlc assay method employing the leuco dye solution which is stabilized as described above. The HbAlc assay method includes the following steps:

a. a step of hemolyzing blood cells by use of a surfactant;

b. a step of cleaving hemoglobin Alc at its β-chain amino terminus by use of a protease which coexists with a leuco dye, thereby providing a fructosyl amino acid or a fructosyl dipeptide;

c. a step of causing an oxidase to act on the fructosyl amino acid or fructosyl dipeptide, the oxidase being specific to the amino acid or dipeptide, thereby generating hydrogen peroxide; and

d. a step of oxidizing the leuco dye with the generated hydrogen peroxide in the presence of a peroxidase, thereby causing the leuco dye to develop color.

In step a, blood cells are hemolyzed by use of a surfactant. Examples of the blood cells include red blood cells. The surfactant is preferably a nonionic surfactant having a polyoxyethylene structure, or an anionic surfactant having a polyoxyethylene structure. Examples of the nonionic surfactant include polyoxyethylene alkyl ethers, polyoxyethylene alkyl phenyl ethers, polyoxyethylene-polyoxypropylene condensation products, polyoxyethylene sorbitan fatty acid esters, polyoxyethylene fatty acid esters, and polyoxyethylene polycyclic surfactants etc. Of these, polyoxyethylene alkyl phenyl ethers are preferred. Examples of the anionic surfactant include polyoxyethylene alkyl sulfate salts, polyoxyethylene alkyl ether sulfate salts, polyoxyethylene alkyl phenyl ether sulfate salts, polyoxyethylene alkyl ether phosphates, polyoxyethylene alkyl sulfosuccinates, polyoxyethylene alkyl ether carboxylate salts, and polyoxyethylene alkyl ether sulfonate salts etc. Of these, polyoxyethylene alkyl ether phosphates, polyoxyethylene alkyl ether sulfate salts, polyoxyethylene alkyl sulfosuccinates, and polyoxyethylene alkyl ether sulfate salts are preferred, with polyoxyethylene alkyl ether sulfate salts being particularly preferred.

The amount of the surfactant employed in the reaction mixture is preferably 0.0001 to 10 mass %, particularly preferably 0.001 to 10 mass %.

In step b, a fructosyl amino acid (i.e., fructosyl valine) or a fructosyl dipeptide (i.e., fructosyl valyl histidine) is cleaved from hemoglobin Alc at its β-chain amino terminus by use of a protease which coexists with a leuco dye. The leuco dye or the protease may be any of the aforementioned leuco dyes or proteases. Reaction conditions are appropriately selected such that a fructosyl amino acid (or a fructosyl dipeptide) can be cleaved from hemoglobin Alc at its β-chain amino terminus in an amount required for performing steps c and d. One of preferred reaction conditions is, for example, at 37° C. for five minutes.

In step c, an oxidase which is specific to the fructosyl amino acid or fructosyl dipeptide is caused to act on the amino acid or dipeptide, to thereby generate hydrogen peroxide. No particular limitation is imposed on the oxidase to be employed, so long as it is a hydrogen peroxide generating oxidase; i.e., an oxidase which can metabolize a glycosylated peptide (e.g., fructosyl peptide) or a glycosylated amino acid (e.g., fructosyl amino acid). The oxidase may be derived from, for example, a microorganism, an animal, or a plant. Alternatively, the oxidase may be produced from a genetically modified microorganism. The oxidase may be chemically modified. Specific examples of the oxidase include fructosyl amino acid oxidases (JP-A-2003-79386 and WO 97/20039), ketoamine oxidase (JP-A-HS-192193), and fructosyl peptide oxidases (JP-A-2001-95598 and JP-A-2003-235585). Of these, fructosyl peptide oxidases are particularly preferred. Examples of fructosyl peptide oxidases include an enzyme obtained through modification of fructosyl amino acid oxidase produced from a bacterium belonging to the genus Corynebacterium (JP-A-2001-95598) and filamentous-fungus-derived fructosyl peptide oxidase (JP-A-2003-235585). FPOX-CE and FPOX-EE (products of Kikkoman Corporation) are particularly preferred. These hydrogen peroxide generating oxidases may be employed in a solution form or in a dry form, or may be supported or bonded onto an insoluble carrier. These hydrogen peroxide generating oxidases may be employed singly or in combination of two or more species.

The amount of a hydrogen peroxide generating oxidase to be employed, which varies with the type of the enzyme, is preferably 0.001 to 1,000 units/mL, particularly preferably 0.1 to 500 units/mL. When a hydrogen peroxide generating oxidase is caused to act on the fructosyl amino acid or fructosyl dipeptide, in consideration of the optimum pH of the enzyme, the pH of the reaction mixture is adjusted to 4 to 9 by use of a buffer. The enzyme is caused to act on the fructosyl amino acid or fructosyl dipeptide at a temperature employed for general enzymatic reaction (preferably at 10 to 40° C.). The buffer to be employed may be any of the aforementioned buffers. No particular limitation is imposed on the concentration of the buffer, but the buffer concentration is preferably 0.00001 to 2 mol/L, particularly preferably 0.001 to 1 mol/L.

If desired, the aforementioned oxidase may be employed in combination with, for example, an additional enzyme or coenzyme. Examples of the other enzymes which may be employed include diaphorase; an amino acid metabolizing enzyme which does not employ fructosyl valine as a substrate; and an enzyme for treating contaminants in blood (e.g., ascorbate oxidase or bilirubin oxidase). Examples of the coenzyme include nicotinamide adenine dinucleotide (NAD), reduced nicotinamide adenine dinucleotide (NADH), nicotinamide adenine dinucleotide phosphate (NADP), reduced nicotinamide adenine dinucleotide phosphate (NADPH), thio-NAD and thio-NADP etc.

In step d, the leuco dye is oxidized with the generated hydrogen peroxide in the presence of a peroxidase, to thereby cause the leuco dye to develop color.

The peroxide to be employed is preferably derived from, for example, horseradish or a microorganism. The peroxidase concentration is preferably 0.01 to 100 units/mL.

Hydrogen peroxide can be conveniently assayed through an enzymatic method employing the peroxidase and the leuco dye within a short period of time. Generally, hydrogen peroxide assay is carried out subsequent to step c (i.e., step of causing a hydrogen peroxide generating oxidase to act on the fructosyl amino acid or fructosyl dipeptide, thereby generating hydrogen peroxide). The pH of the solution for hydrogen peroxide assay is preferably adjusted to 5 to 8 by use of the aforementioned buffer. The extent of color development (change in absorbance) is measured by means of a spectrophotometer, and the resultant data are compared with the absorbance of a standard whose concentration is known (e.g., fructosyl dipeptide or fructosyl amino acid), whereby hemoglobin Alc contained in a sample can be assayed. Hemoglobin Alc can be assayed by means of a generally employed autoanalyzer.

### EXAMPLES

The present invention will next be described in more detail by way of Examples, which should not be construed as limiting the invention thereto.

### Example 1

Stabilization of TPM-PS

Each of the proteases shown in Table 1 was added to a PIPES buffer (pH 6.0) containing TPM-PS (100 μM), and the resultant mixture was stored at 37° C. Subsequently, absorbance was measured at 600 nm by means of an autoanalyzer (model: 7150, product of Hitachi, Ltd.). The thus-obtained data were compared. Table 1 shows absorbance 0 hours after addition of the protease protein, and absorbance after one-week storage.

In Table 1, the term “inactivated” refers to the case where a protease is thermally treated at 70° C. for four hours before being added to the buffer.

TABLE 1

| | | 1 Week |
|---|---|---|
| | | later |
| Solution | 0 Hrs later | (37° C.) |
| 50 mM PIPES (pH 6) | 0.017 | 0.380 |
| 50 mM PIPES (pH 6) + 0.1 mg/mL Protin | 0.007 | 0.179 |
| 50 mM PIPES (pH 6) + 1.0 mg/mL Protin | 0.006 | 0.199 |
| 50 mM PIPES (pH 6) + 0.1 mg/mL inactivated | 0.007 | 0.213 |
| Protin | | |
| 50 mM PIPES (pH 6) + 1.0 mg/mL inactivated | 0.007 | 0.200 |
| Protin | | |
| 50 mM PIPES (pH 6) + 0.1 mg/mL Protease Type | 0.006 | 0.097 |
| XXIII | | |
| 50 mM PIPES (pH 6) + 1.0 mg/mL Protease Type | 0.005 | 0.133 |
| XXIII | | |
| 50 mM PIPES (pH 6) + 0.1 mg/mL inactivated | 0.006 | 0.183 |
| Actinase E | | |
| 50 mM PIPES (pH 6) + 1.0 mg/mL inactivated | 0.007 | 0.165 |
| Actinase E | | |

As is clear from Table 1, when Protin is added to a TPM-PS-containing solution (pH: about 6), the extent of nonspecific color development of TPM-PS is reduced to about 1/2 that in the case where Protin is not added to a TPM-PS-containing solution. That is, addition of Protin stabilizes TPM-PS. The results also reveal that addition of inactivated Protin reduces nonspecific color development of TPM-PS and stabilizes TPM-PS.

Also, addition of Protease Type XXIII reduces nonspecific color development of TPM-PS and stabilizes TPM-PS.

Furthermore, addition of inactivated Actinase E reduces nonspecific color development of TPM-PS and stabilizes TPM-PS.

### Example 2

Measurement of HbAlc Level

<Hemolyzing Reagent>

2% Emal 20C (product of Kao Corporation)

<Reagent (1)>

50 mM PIPES solution (pH 6)

2 mM Calcium chloride

1.5 mg/mL Protin PC10F

25 μM TPM-PS (product of Dojindo Laboratories)

<Reagent (2)>

50 mM Citrate buffer (pH 6)

10 units/mL POD (product of Toyobo Co., Ltd.)

6 units/mL FPOX-CE (product of Kikkoman Corporation)

(1) Preparation of Hemolyzed Sample

Human blood cell samples (30 samples) were employed. The hemolyzing reagent (450 μL) was added to each of the blood cell samples (12 μL), to thereby prepare hemolyzed samples.

(2) Measurement

The reagent (1) (180 μL). was added to the hemolyzed sample (15 μL), and the resultant mixture was incubated at 37° C. for five minutes. Thereafter, the difference between absorbance at 600 nm (primary wavelength) and absorbance at 700 nm (secondary wavelength) was measured, and a hemoglobin-level-dependent measurement (samp Hb) was obtained. Subsequently, the reagent (2) (60 pL) was added to the above-obtained reaction mixture, followed by reaction at 37° C. for five minutes. A change in the difference between absorbance at 600 nm (primary wavelength) and absorbance at 700 nm (secondary wavelength) was measured, and an HbAlc-level-dependent measurement (samp Al) was obtained. Separately, a sample whose HbAlc level (%) is known was subjected to a procedure similar to that described above, and a hemoglobin-level-dependent measurement (std Hb) and an HbAlc-level-dependent measurement (std Al) were obtained. On the basis of these measurements, the HbAlc level (%) of the hemolyzed sample was calculated by use of the following formula. Measurement was performed by means of an autoanalyzer (model: 7170, product of Hitachi, Ltd.).

HbAlc (%) =std HbAl× (std Hb/std Al )× (samp Al/samp Hb) (std HbAl:HbAlc level (%) of a sample whose HbAlc level is known)

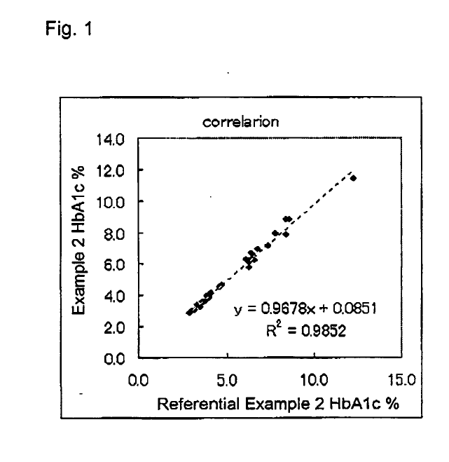

FIG. 1 shows correlation between the thus-calculated HbAlc level (%) and that in the case of Referential Example (Table 2) as measured through an immunological measuring method employing a commercially available kit (Determiner HbAlfc, product of Kyowa Medex Co., Ltd.). Regarding the Referential Example, Table 2 shows JDS (%), and IFCC (%) calculated from JDS (%) by use of the following calculation formula.

IFCC (%)=1.0681x−1.7407 (see Journal of the Japan Diabetes Society Vol.46 (9), 2002)

TABLE 2

| Referential | Example 2 | |
|---|---|---|
| Example | Hb | HbA1c |

| | JDS % | IFCC % | mg/dL | mg/dL | HbA1c % |
|---|---|---|---|---|---|
| 1 | 13.1 | 12.3 | 545.4 | 62.2 | 11.40 |
| 2 | 9.7 | 8.6 | 675.6 | 59.7 | 8.84 |
| 3 | 9.5 | 8.4 | 846.8 | 66.3 | 7.83 |
| 4 | 8.9 | 7.8 | 849.6 | 67.3 | 7.92 |
| 5 | 8.6 | 7.4 | 581.6 | 41.6 | 7.15 |
| 6 | 8 | 6.8 | 837.8 | 58.2 | 6.95 |
| 7 | 7.7 | 6.5 | 640.1 | 42.3 | 6.61 |
| 8 | 7.6 | 6.4 | 794.6 | 49.8 | 6.26 |
| 9 | 7.5 | 6.3 | 776.5 | 47.1 | 6.07 |
| 10 | 7.4 | 6.2 | 772.3 | 48.2 | 6.24 |
| 11 | 7.3 | 6.1 | 853.1 | 53.7 | 6.29 |
| 12 | 6 | 4.7 | 807.1 | 37.5 | 4.64 |
| 13 | 5.9 | 4.6 | 828.0 | 37.4 | 4.52 |
| 14 | 5.3 | 3.9 | 817.6 | 32.2 | 3.94 |
| 15 | 5.4 | 4.0 | 836.4 | 32.3 | 3.86 |
| 16 | 5.5 | 4.1 | 771.6 | 31.8 | 4.12 |
| 17 | 5.1 | 3.7 | 830.1 | 29.4 | 3.55 |
| 18 | 5 | 3.6 | 869.8 | 30.9 | 3.55 |
| 19 | 4.9 | 3.5 | 663.1 | 21.5 | 3.24 |
| 20 | 4.7 | 3.3 | 823.2 | 27.7 | 3.36 |
| 21 | 4.6 | 3.2 | 815.5 | 25.0 | 3.06 |
| 22 | 4.4 | 3.0 | 806.5 | 24.1 | 2.99 |
| 23 | 4.3 | 2.9 | 823.9 | 23.6 | 2.87 |
| 24 | 9.5 | 8.4 | 801.6 | 70.4 | 8.79 |
| 25 | 7.7 | 6.5 | 823.2 | 51.6 | 6.26 |
| 26 | 7.6 | 6.4 | 617.8 | 41.2 | 6.67 |
| 27 | 7.8 | 6.6 | 693.0 | 42.9 | 6.20 |
| 28 | 7.5 | 6.3 | 830.8 | 47.9 | 5.76 |
| 29 | 5.4 | 4.0 | 851.0 | 32.7 | 3.84 |
| 30 | 5.2 | 3.8 | 855.2 | 30.9 | 3.62 |

What is claimed is:

1. A method for stabilizing a leuco dye, comprising storing a leuco dye in a solution in the co-presence of a protease protein.

2. The method according to claim 1, wherein the leuco dye is a triphenylmethane leuco dye.

3. The method according to claim 2, wherein the leuco dye is N,N,N′,N′,N″,N″-hexa-3-sulfopropyl-4,4′,4″-triaminotriphenylmethane.

4. The method according to claim 1, wherein the protease protein is at least one species selected from among a protease derived from the genus Bacillus, a protease derived from the genus Aspergillus, and a protease derived from the genus Streptomyces.

5. The method according to claim 4, wherein the protease derived from the genus Bacillus is Subtilisin.

6. The method according to claim 4, wherein the protease derived from the genus Aspergillus is Aspergillopepsin I or Protease type XXIII.

7. The method according to claim 4, wherein the protease derived from the genus Streptomyces is Mycolysin.

8. A leuco dye solution containing at least a protease protein.

9. A reagent kit for assaying hydrogen peroxide, the kit comprising, as a reagent, a leuco dye solution as recited in claim 8.

10. A method of employing a protease protein as a leuco dye stabilizing agent.

11. A method for assaying hemoglobin Alc, comprising the following steps:
a. a step of hemolyzing blood cells by use of a surfactant;
b. a step of cleaving hemoglobin Alc at its β-chain amino terminus by use of a protease which coexists with a leuco dye, thereby providing a fructosyl amino acid or a fructosyl dipeptide;
c. a step of causing an oxidase to act on the fructosyl amino acid or fructosyl dipeptide, the oxidase being specific to the amino acid or dipeptide, thereby generating hydrogen peroxide; and
d. a step of oxidizing the leuco dye with the generated hydrogen peroxide in the presence of a peroxidase, thereby causing the leuco dye to develop color.

12. A reagent for use in a method for assaying hemoglobin Alc, the method comprising the following steps;
a. a step of hemolyzing blood cells by use of a surfactant;
b. a step of cleaving hemoglobin Alc at its β-chain amino terminus by use of a protease which coexists with a leuco dye, thereby providing a fructosyl amino acid or a fructosyl dipeptide;
c. a step of causing an oxidase to act on the fructosyl amino acid or fructosyl dipeptide, the oxidase being specific to the amino acid or dipeptide, thereby generating hydrogen peroxide; and
d. a step of oxidizing the leuco dye with the generated hydrogen peroxide in the presence of a peroxidase, thereby causing the leuco dye to develop color.
